(19) United States
(12) Patent Application Publication
(10) Pub. No.: US 2007/0119090 A1
(43) Pub. Date: May 31, 2007

(54) Fishing lure

(76) Inventor: Jeremy R. Searcy, Dry Ridge, KY (US)

Correspondence Address: SUNG I. OH, PROFESSIONAL LAW CORPORATION, 710 QUAIL VALLEY LANE, WEST COVINA, CA, 91791, US

(21) Appl. No.: 11/287,990

(22) Filed: Nov. 28, 2005

(51) Int. Cl. A01K 85/00

(52) U.S. Cl. 43/42.47; 43/42.24; 43/42.39

(57) ABSTRACT

A fishing lure that is in the form of a minnow and is weighted and designed to assume an orientation that appears to be a dying minnow as the lure is pulled through the water by a fisherman. The lure undulates on its side as it is pulled through the water.

### TECHNICAL FIELD OF THE INVENTION

The present invention relates to the general art of fishing, and to the particular field of fishing lures.

### BACKGROUND OF THE INVENTION

Fishing lures are typically attached to a fishing line and pulled through the water by a fisherman. Lures which simulate live bait have been used for many years and are available in various sizes and shapes. Many fishermen prefer lures instead of live bait for various reasons, including ease of handling and the economic advantages of not having to purchase or capture live bait.

Fishing lures generally comprise essentially two components, namely some sort of fish-hooking component or mechanism and some sort of body member which serves the plural functions of carrying the fish-hooking component, providing a weight by which the fish-hooking component may be propelled, providing the connection between the fish-hooking component and the fishing line, and providing an appealing attraction which hopefully will entice a fish to strike the lure and thereby be caught.

It is known in the art to provide fishing lures which simulate the movement of various types of live bait. Typically, such lures must be pulled through the water by the fisherman at a relatively high speed in order to simulate the movement of live bait. Further, the simulated movement is usually limited to one particular type of movement. Some lures simulate the color or shape of various types of live bait. Still other types of lures emit sounds which ostensibly attract fish

More specifically, plug type lures for casting and trolling, resembling small baitfish, are known in the prior art. Numerous theories have been developed to explain why some lures attract and trigger the striking instinct of a gamefish. Among these theories, varying emphasis has been placed on the role of the shape, color, sound and motion of a successful lure.

One theory holds that gamefish are strongly attracted to weak, injured fish which move in erratic injured actions. It is claimed in this instance that the movements and sounds of the bait draw strike after strike until a predator gamefish hooks itself.

The effectiveness and movements of a lure are dependent upon features which are specific to the construction of the lure. These features have ranged from internal baffles to gas discharge means in the prior art.

The action of an injured minnow as it moves through water includes a large amount of tail action relative to its forward motion. A fish observing the motion of the injured minnow recognizes it as easy prey and will attack it.

Therefore, the art has included examples of lures that simulate the darting behavior and sounds of an injured baitfish with the object of enhancing the chances of attracting the target fish. More specifically, the art has included examples of fishing lures which simulate the action of an inured minnow.

However, the inventor has observed that while lures that simulate movements of an injured minnow are more effective than other types of lures, a dying baitfish, such as a minnow, is even more attractive to a game fish.

Therefore, there is a need for a fishing lure that simulates the movements of a dying minnow as the lure is pulled through the water by the fisherman.

### SUMMARY OF THE INVENTION

The above-discussed disadvantages of the prior art are overcome by a fishing lure that simulates the swimming action of a dying minnow as the lure is pulled through the water by a fisherman. The lure includes a fin on the front end thereof and the lure flops onto its side and imitates the motion of a minnow struggling to live similar to that of a dying minnow moving through the water as the lure is pulled through the water by the fisherman.

While game fish will be attracted to injured fish, the game fish will instinctively know that a dying fish is even easier prey. Accordingly, a dying baitfish will be still more attractive to a game fish than even an injured baitfish.

Using the lure embodying the present invention will permit a fisherman to attract game fish by simulating the movements of a dying baitfish as the lure is pulled through the water by the fisherman. The dying baitfish is more likely to attract a target fish than a lure that merely simulates the swimming motion of a healthy baitfish and will still more attractive to a game fish than even a baitfish that is simply injured.

Other systems, methods, features, and advantages of the invention will be, or will become, apparent to one with skill in the art upon examination of the following figures and detailed description. It is intended that all such additional systems, methods, features, and advantages be included within this description, be within the scope of the invention, and be protected by the following claims.

### BRIEF DESCRIPTION OF THE DRAWING FIGURES

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of a fishing lure embodying the present invention.

FIG. 2 is a sectional view taken along line 2-2 of FIG. 1.

### DETAILED DESCRIPTION OF THE INVENTION

Referring to the figures, it can be understood that the present invention is embodied in a fishing lure 10 that simulates a dying minnow when pulled through water.

Lure 10 comprises a body 12 formed of soft flexible material, such as rubber or soft plastic and which can be decorated to appear like a minnow with scales 14, eyes 16 and the like. Lure 10 is adapted to move through water when pulled by a fisherman. Body 12 is able to assume either a dying-minnow orientation lying on its side or a swimming-minnow-orientation.

Body 12 has a first end 20 which is a forward end when the body is pulled through the water, a second end 22 which is an aft end when the body is pulled through the water and a longitudinal axis 24 which extends between first end 20 and second end 22. Body 12 further includes a first side 30 which is a top side when the body is oriented in the dying-minnow-orientation, a second side 32 which is a bottom side when the body is oriented in the dying-minnow-orientation and a width axis 36 which extends between first side 30 and second side 32. Body 12 further includes a first surface 40 which is a top surface when the body is in the swimming-minnow-orientation, a second surface 42 which is a bottom surface when the body is in the swimming-minnow-orientation and a height axis 44 which extends between first surface 40 and second surface 42.

Fish hooks, such as hooks 60 and 62 are fixed to body 12 by eyes 64 and 66 respectively. A fin 70 is mounted on first end 20 of the body and includes a first end 72 located adjacent to first surface 40 of the body, a second end 74 which is located adjacent to second surface 42 of the body and a longitudinal axis 76 which extends between first end 72 of the fin and second end 74 of the fin and which is oriented to extend in a direction that is essentially parallel to height axis 44 of flexible body 12.

Fin 70 further includes an arcuate end 80 which is a leading end when flexible body 12 is pulled through the water, a base end 82 which is fixed to first end 20 of flexible body 12 and a transverse axis 86 which extends between arcuate end 80 and base end 82 of the fin and which is oriented to extend in a direction that is essentially parallel to longitudinal axis 24 of the flexible body.

Fin 70 further includes a first side 90 which is located adjacent to first side 30 of flexible body 12 and a second side 92 which is located adjacent to second side 32 of the flexible body.

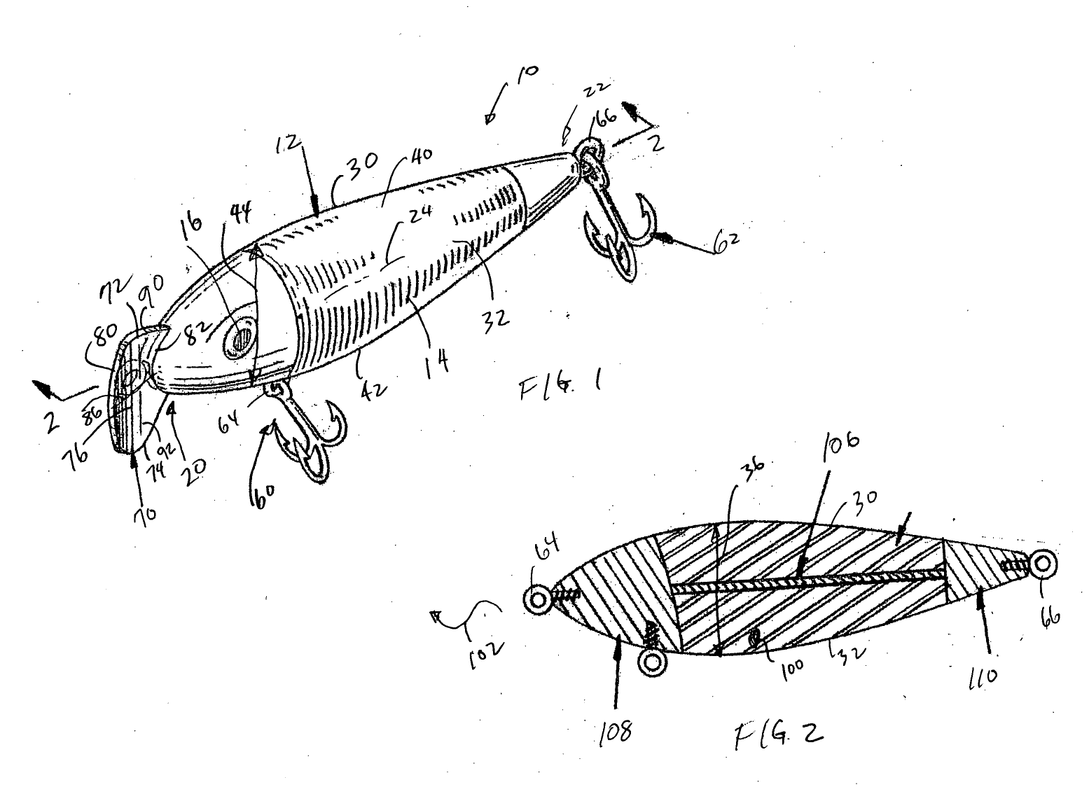

As can be understood from FIG. 1, fin 70 is fixed to flexible body 12 at a location that is spaced apart from the longitudinal axis of the flexible body and which is also spaced apart from the height axis of the flexible body whereby the fin is off-center with respect to the flexible body. The fin is also shaped and oriented so that when the lure is pulled through the water, the fin will force the lure onto its side and work in conjunction with the flexible nature of the body to cause the lure to undulate up and down on its side as it moves through the water. This undulating motion resembles that of a dying fish as it struggles through the water. This will attract a game fish as the game fish will mistake the lure for a dying food fish.

An alternative form of the lure includes a weight element 100 in flexible body 12 and located in the flexible body to cause the flexible body to be oriented so height axis 94 of the flexible body is oriented in a horizontal plane with first side 30 on top and width axis 36 is in a vertical plane when the flexible body is in the water.

As discussed above, the fin is shaped and oriented to cause the flexible body to undulate with the first and second surfaces of the flexible body undulating up and down in a vertical plane as the flexible body is pulled through the water as indicated by arrow 102 in FIG. 2. The shape and location of fin 70 can work in conjunction with the weight element to further enhance the undulating motion of the lure as it moves through the water.

A connector element 106 can be used to ensure the integrity of the lure. In one form of the invention, connector element 106 is a steel cable which will ensure the integrity of the lure but which will also permit the above-discussed undulating movement of the lure as it moves through the water under the influence of fin 70 and weight element 100. The head section 108 and the tail section 110 can be formed of hard plastic if desired. The connector element 106 may connect the head section 108 and the tail section 110 together.

While various embodiments of the invention have been described, it will be apparent to those of ordinary skill in the art that many more embodiments and implementations are possible within the scope of this invention. Accordingly, the invention is not to be restricted except in light of the attached claims and their equivalents.

What is claimed is:

1. A fishing lure for simulating a dying minnow when pulled through water comprising:
A) a body formed of soft flexible material and being adapted to move through water when pulled by a fisherman, the body being able to assume either a dying-minnow orientation lying on its side or a swimming-minnow-orientation, the body having
(1) a first end which is a forward end when the body is pulled through the water,
(2) a second end which is an aft end when the body is pulled through the water,
(3) a longitudinal axis which extends between the first end of the body and the second end of the body,
(4) a first side which is a top side when the body is oriented in the dying-minnow-orientation,
(5) a second side which is a bottom side when the body is oriented in the dying-minnow-orientation,
(6) a first surface which is a top surface when the body is in the swimming-minnow-orientation,
(7) a second surface which is a bottom surface when the body is in the swimming-minnow-orientation,
(8) a height axis which extends between the first surface of the body and the second surface of the body, and
(9) a width axis which extends between the first side of the body and the second side of the body;
B) a fish hook fixed to the body;
C) a fin mounted on the first end of the body and including
(1) a first end located adjacent to the first surface of the body,
(2) a second end which is located adjacent to the second surface of the body,
(3) a longitudinal axis which extends between the first end of the fin and the second end of the fin and which is oriented to extend in a direction that is essentially parallel to the height axis of the flexible body,
(4) an arcuate end which is a leading end when the flexible body is pulled through the water,
(5) a base end which is fixed to the first end of the flexible body,
(6) a transverse axis which extends between the arcuate end of the fin and the base end of the fin and which is oriented to extend in a direction that is essentially parallel to the longitudinal axis of the flexible body,
(7) a first side which is located adjacent to the first side of the flexible body,
(8) a second side which is located adjacent to the second side of the flexible body,
(9) the fin being fixed to the flexible body at a location that is spaced apart from the longitudinal axis of the flexible body and which is also spaced apart from the height axis of the flexible body whereby the fin is off-center with respect to the flexible body; and
D) a weight element in the flexible body which is located in the flexible body to cause the flexible body to be oriented so the height axis of the flexible body is oriented in a horizontal plane with the first side on top and the width axis is in a vertical plane when the flexible body is in the water, the fin being shaped and oriented to cause the flexible body to undulate with the first and second surfaces of the flexible body undulating up and down in a vertical plane as the flexible body is pulled through the water.

2. The lure defined in claim 1 further including a plurality of fish hooks.

3. The lure defined in claim 1 further including a connector element which extends between the first end of the flexible body and the second end of the flexible body.

4. A fishing lure for simulating a dying minnow when pulled through water comprising:
A) a body formed of soft flexible material and being adapted to move through water when pulled by a fisherman, the body being able to assume either a dying-minnow orientation lying on its side or a swimming-minnow-orientation;
B) a fish hook fixed to the flexible body; and
C) a fin mounted on the flexible body, the fin being fixed to the flexible body at a location that is off-center with respect to the flexible body, the fin being shaped and oriented to cause the flexible body move into the dying-minnow orientation lying on its side and to undulate up and down in a vertical plane as the flexible body is pulled through the water.

5. The fishing lure according to claim 4, further including a head section and a tail section made from a hard plastic, and the body between the head and tail sections, a connector element within the body to attach the head and tail sections together.
